(19) United States
(12) Patent Application Publication
(10) Pub. No.: US 2005/0229954 A1
(43) Pub. Date: Oct. 20, 2005

(54) Vehicle washing system

(75) Inventors: Craig Rosselott, Hillsboro, OH (US); Kent Oltmann, Denver, IA (US); Karl Byrer, Denver, CO (US)

Correspondence Address: DANE C. BUTZER, 870 HIGH STREET, SUITE 104, WORTHINGTON, OH, 43085, US

(73) Assignee: Hydro-Spray, Mansfield, OH (US)

(21) Appl. No.: 10/963,182

(22) Filed: Oct. 12, 2004

Related U.S. Application Data
(60) Provisional application No. 60/563,880, filed on Apr. 19, 2004.
(60) Provisional application No. 60/565,735, filed on Apr. 27, 2004.

(51) Int. Cl. B08B 3/00

(52) U.S. Cl. 134/34; 134/123; 134/198; 134/172; 134/199

(57) ABSTRACT

A vehicle washing system. One embodiment includes a carriage, at least two towers attached to the carriage, a drive mechanism that moves the towers about a vehicle, and a plurality of rotating wands recessed into each of the towers. The wands including nozzles through which high pressure fluid is sprayed onto the vehicle. Also, a method of using the system.

### BACKGROUND OF THE INVENTION

1. Field of the Invention

This invention relates to automatic vehicle washing systems, and in particular to a system that has two towers with two-nozzled rotating wands.

2. Description of the Related Art

“No-touch” car wash systems are becoming increasingly popular. These systems operate by spraying pre-soaks, water, soaps, liquid waxes, etc. in succession onto a car under high pressure. No wash clothes, brushes, or the like come into actual contact with the vehicle, hence the term “no-touch.” This has the benefit that the vehicle is less likely to be scratched by rough or dirty clothes, brushes, or the like.

Existing no-touch mechanical wash systems for automatic car washes come in several types: single tower systems with directly attached nozzles, single tower systems with three-nozzled rotating wands, and two tower systems with directly attached nozzles.

Single tower systems with directly attached nozzles: These systems suffer from a problem that the nozzles spray in lines across a vehicle. Areas between the lines do not receive any direct jets of water or other agents. As a result, wash efficiency can be less than satisfactory.

Single tower systems with three-nozzled rotating wands: Water is sprayed onto a car using rotating wands. Soap and other agents are sprayed through separate nozzles. The wands in these systems generally have three arms with nozzles at their ends, for example shaped as shown in FIG. 5.

The arms are usually around one and a half feet long. Several of the wands could be present on a tower. The wands rotate, resulting in a swirling motion of water jets striking a vehicle. This approach tends to strike much more of a vehicle's surface with direct jets of water. However, this approach is not without its problems.

In particular, the three-nozzled wands are too large to be recessed within a tower. As a result, the rotating ends of the wands are exposed and can strike improperly situated vehicles, resulting in damage. The rotating ends also can strike maintenance personnel and attendants, who often need to see the wash mechanism in operation to diagnose problems. This is a serious safety issue. Furthermore, if the wands strike a vehicle or a person, the wands can break, putting the entire wash bay out of commission.

In addition, towers that can accommodate the three-nozzled wands are generally too large (e.g., 36″ wide) for more than one tower to be conveniently and economically mounted in a wash bay. Even if two such towers could be effectively mounted, synchronization of the large towers presents difficult problems. The large towers also can be visually intimidating to customers.

Finally, the circles traced by jets from nozzles of the three-nozzled wands tend to be so large that some areas of a vehicle do not receive any direct jets of water.

Despite these problems, single tower systems with thee-nozzled rotating wands have held a dominant position in the automatic wash bay industry for well over a decade.

Two tower systems with directly attached nozzles: These systems increase throughput for an automatic wash bay. However, these systems suffer from the same coverage problems as one-tower systems with directly attached nozzles. Nonetheless, these systems have also held a dominant position in the automatic wash bay industry.

### SUMMARY OF THE INVENTION

A need exists for a vehicle washing system that addresses the foregoing issues. One embodiment of the invention addresses these issues with a vehicle washing system that includes a carriage, at least two towers attached to the carriage, a drive mechanism that moves the towers about a vehicle, and a plurality of rotating wands recessed into each of the towers. The wands include nozzles through which high-pressure fluid is sprayed onto the vehicle.

The nozzles on the rotating wands provide better coverage than directly attached nozzles. The recessed wands are less likely to strike improperly situated vehicles, maintenance personnel and attendants. As a result, the system is safer and is less likely to be knocked out of commission.

In a preferred embodiment, each of the wands further includes a rotating arm with a nozzle at or near each end of the arm. The wands preferably are about half a foot long. These smaller wands facilitate use of thinner towers, simplifying use and operation of the two-towered system.

Preferably at least three wands are mounted on each tower. One or more fixed nozzles, oscillating nozzles, or both fixed and oscillating nozzles also can be mounted on each tower.

In one embodiment, the drive mechanism moves the towers about a vehicle by moving the carriage back and forth over the vehicle and by rotating the towers together behind and in front of the vehicle at the ends of the carriage movement. The drive mechanism preferably uses one variable speed motor to move the carriage back and forth and another variable speed motor to move the towers. Rails that guide motion of the carriage preferably are made from four-inch by two-inch rectangular tubing. This design results in a simpler and less expensive system that should not need as extensive bracing and gusseting as existing systems.

One or more fixed nozzles, oscillating nozzles, rotating wands with nozzles, or some combination thereof can be mounted on the carriage and on the arms that connect the carriage to the towers. These wands and nozzles can be used to spray at least a top of the vehicle. If one or more rotating wands are used, a separate motor can be used to rotate the wands.

In some embodiments, water and agents such as pre-soaks, soaps, cleansers, liquid waxes, protectants, foams, spot free rinses, and the like are all sprayed through the nozzles of the rotating wands. In other embodiments, separate nozzles for some or all of the agents can be used.

The invention also encompassed methods of using the foregoing arrangements.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 shows a vehicle wash system.

FIG. 2 shows a tower with recessed rotating wands for a vehicle wash system.

FIG. 3 shows a rotating wand.

FIG. 4 is a top view of a vehicle wash system showing further details and operation of the system.

FIG. 5 shows a prior art three-armed wand.

### DESCRIPTION OF THE PREFERRED EMBODIMENTS

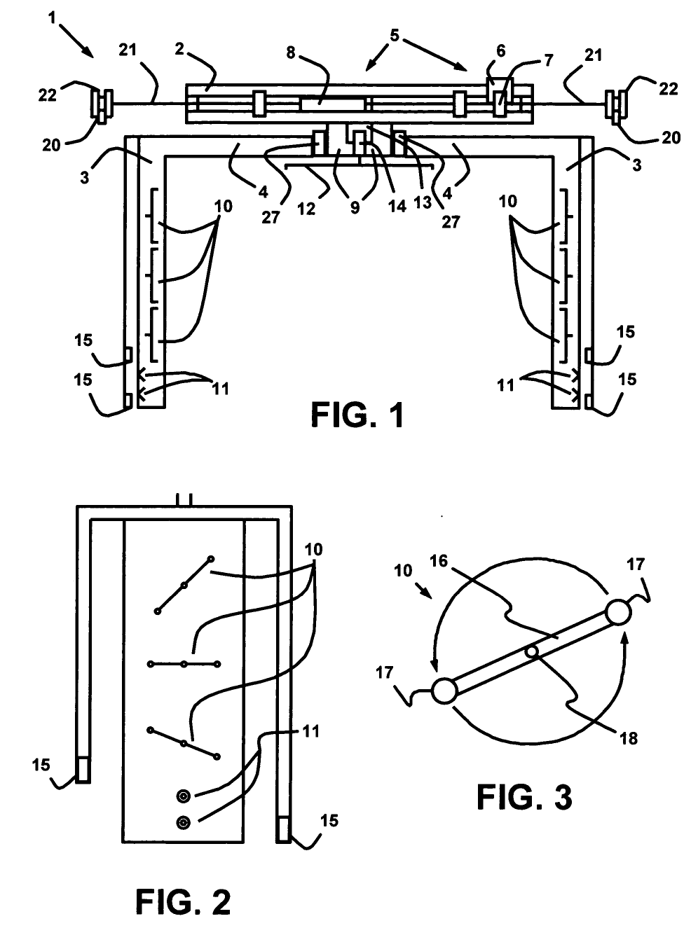

FIG. 1 shows a vehicle wash system, for example for use in an automatic car wash. Briefly, the system includes a carriage, at least two towers attached to the carriage, a drive mechanism that moves the towers about a vehicle, and a plurality of rotating wands recessed into each of the towers. The wands include nozzles through which high-pressure fluid is sprayed onto the vehicle.

In more detail, system 1 includes carriage 2 and towers 3 attached to carriage 2 via arms 4. When a vehicle is situated in the system, drive mechanism 5 moves the towers about the vehicle. As shown in FIG. 1, drive mechanism 5 includes motor 6 and linkage 7 (e.g., a gearbox or reducer) for moving carriage 2 back and forth over a car. The drive mechanism preferably also includes a second motor 8 and linkages 9 for swinging towers 3 together and apart at the front and back of a vehicle. Variable speed motors are preferably used so as to afford a wide range of operating speeds for the system.

Although the towers are shown as straight in FIG. 1, they can be bent or curved to better follow the general shape of a typical vehicle.

Plural rotating wands 10 are recessed into each of the towers. The wands including nozzles through which high pressure fluid is sprayed onto the vehicle. In a preferred embodiment, rotation of the wands is driven by one or more motors (not shown) in each of the arms or towers. Other arrangements for driving the wands can be used without departing from the invention.

In the context of this invention, “recessed” means that some portions or flanges on towers 3 extend past at least part of wands 10 when the towers are viewed edge-on as in FIG. 1. The wands can be completely or partially recessed. In the view shown in FIG. 1, the wands are completely recessed and would actually be hidden from view by the edges of towers 3. However, the wands are shown in the figure for the sake of explanation.

The nozzles on rotating wands 10 provide better coverage than directly attached nozzles. The recessed wands are less likely to strike improperly situated vehicles, maintenance personnel and attendants. As a result, the system is safer and is less likely to be knocked out of commission.

One or more fixed nozzles, oscillating nozzles, or both fixed and oscillating nozzles can be mounted on each tower to provide additional coverage for spraying a vehicle. For example, in a preferred embodiment, nozzles 11 include oscillating nozzles at the bottom of the towers that can be used to spray rocker panels, wheels, and tires. Preferably these nozzles are under separate control (e.g., through valves) so that the nozzles optionally can be used by themselves. This arrangement permits application of presoak(s) on the wheels and tires while dry so as to prevent dilution of tire and wheel cleaner and the like.

In a preferred embodiment, one or more rotating wands such as wand 12 are mounted on carriage 2 and/or arms 4 to spray at least a top of a vehicle. These wands preferably have their own drive mechanism, shown in FIG. 1 as motor 13 and linkage 14, although such need not be the case.

Other arrangements including fewer or more wands and nozzles attached to the towers, carriage, and/or arms can be used without departing from the invention.

In a preferred embodiment, the fluid sprayed through the various nozzles includes at least water. The same nozzles or different nozzles can be used to spray agents besides water, for example pre-soaks, soaps, cleansers, liquid waxes, protectants, foams, spot free rinses, and the like. These fluids can be delivered to system 1 via pipes or hoses (not shown).

The structures shown in FIG. 1 preferably are made from suitably strong, light-weight, and water resistant materials. The towers themselves preferably are made from blow molded plastic. Use of plastic for the towers helps to prevent damage to vehicles that contact the towers. Other types of covers and materials, for example made of suitable metal or aluminum materials, can be used without departing from the invention. If metal is used (and in any other case), covers such as plastic covers can be used to protect the towers and to protect vehicles from serious damage if they contact the towers.

FIG. 1 also shows sensors 15 used to detect when towers 3 have been moved near the front or back of a vehicle and can be swung together. In a preferred embodiment, sensors 15 are a combination of “photoeyes” and proximity sensors. Photoeyes includes both a light source and a photo detector. The light source on one photoeye is aligned with the photo detector on another photoeye. These are used to sense the front and rear of the vehicle. Proximity sensors detect a metallic target surface. These are used to correctly control the position of the arms during the wash process and to provide movement limits for the carriage. Other types of sensors can be used. A preferred arrangement of the sensors is discussed in more detail below with respect to FIG. 2.

FIG. 2 shows a tower with recessed rotating wands for a vehicle wash system. Tower 3 has three rotating wands 10 mounted on it, as well as two fixed or oscillating nozzles 11. Other embodiments of the invention could include more or fewer wands and nozzles in different combinations and positions.

FIG. 2 also shows one possible arrangement of sensors 15. In this arrangement, a lower sensor mounted on a vertical support on the front end of one side of the carriage is aligned with a higher sensor on a vertical support on the opposite side of the carriage, resulting in sensor beams that are angled with respect to the ground. The angled sensor beams are more likely to strike front-most and rear-most features of a vehicle than sensor beams that are parallel to the ground. A second set of sensors are located in the same manner across the other side of the carriage, as shown in FIG. 1, with higher and lower sensors reversed with respect to side. In this arrangement, the front sensors can detect the front of a vehicle and the rear sensors can detect the rear of the vehicle. Other sensor arrangements are possible without departing from the invention.

FIG. 3 shows an example of a rotating wand that can be used with system 1. In a preferred embodiment, each of wands 10 includes rotating arm 16 with two nozzles 17 at or near the ends of the arm. The wand rotates about an axis 18, as indicated by the curved arrows in FIG. 3. The wands can rotate clockwise and counterclockwise. All wands 10 in an embodiment of the invention could rotate in the same direction, or different wands could rotate in different directions.

The wands preferably are about half a foot long. These smaller wands facilitate use of thinner towers, simplifying use and operation of the two-towered system. Other sizes and designs of wands with different placements and possibly numbers of nozzles can be used without departing from the invention.

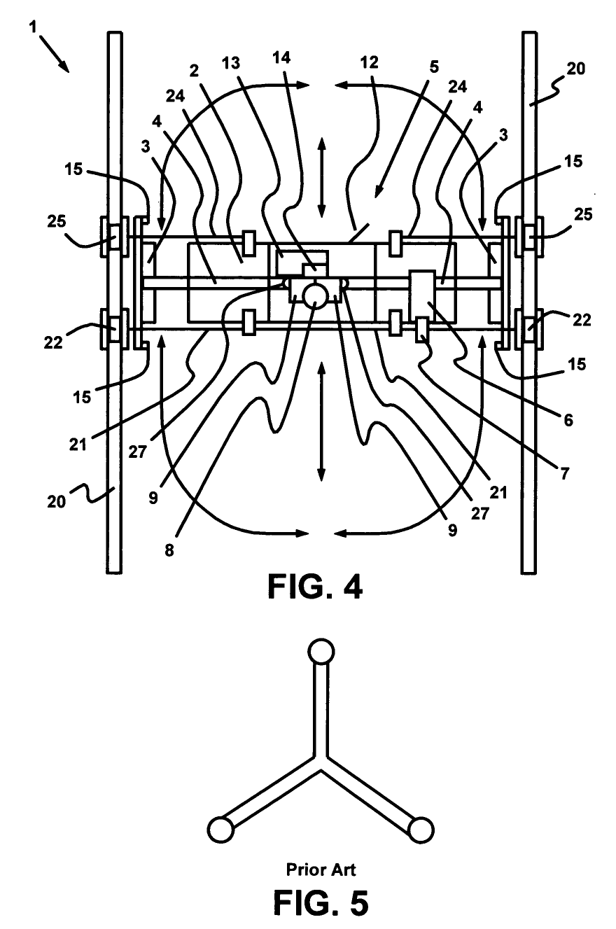

FIG. 4 is a top view of vehicle wash system 1 showing further details and operation of the system. In the figure, carriage 2 with drive mechanism 5 moves back and forth on rails 20. Movement of carriage 2 is driven by motor 6 and linkage 7 of drive mechanism 5, which in turn drive shaft 21 and wheels 22 on rails 20. Additional undriven shafts 24 and wheels 25 are used to provide added stability. Other arrangements can be used to move carriage 2 without departing from the invention.

In a preferred embodiment, rails 20 are tracks made from four-inch by two-inch rectangular tubing. This type of track differs from that used in other systems. A benefit of using the four-inch by two-inch rectangular tubing is that much of the bracing and gusseting used by those other systems can be eliminated. Different types of rails and tracks and possibly additional bracing and gusseting can be used without departing from the invention.

A controller (not shown) causes motor 6 and linkage 7 to move carriage 2 to near the front and back of a vehicle based on input from sensors 15. At both the front and back of the vehicle, the controller causes motor 8 and linkages 9 to swing arms 4 and thus towers 3 together and then back apart. In FIG. 4, arms 4 swing on pivot points 27 attached to linkages 9. Other arrangements can be used to swing the towers without departing from the invention.

In FIG. 4, the stopping location of carriage 2 determines how far the towers will be from a vehicle when they swing together. The result is a consistent washing action for the fronts and rears of different vehicles even if those vehicles differ significantly in size.

By virtue of the foregoing features, the invention addresses the need for an effective vehicle washing system that is economically feasible to build and to maintain, that provides good washing action, that provides improved throughput by virtue of using two towers to wash a vehicle, and that has improved safety characteristics.

### ALTERNATIVE EMBODIMENTS

The invention is in no way limited to the specifics of any particular preferred embodiment disclosed herein. Many variations are possible which remain within the content, scope and spirit of the invention, and these variations would become clear to those skilled in the art after perusal of this application.

1. A vehicle washing system, comprising:
a carriage;
at least two towers attached to the carriage;
a drive mechanism that moves the towers about a vehicle; and
a plurality of rotating wands recessed into each of the towers, the wands including nozzles through which high pressure fluid is sprayed onto the vehicle.

2. A vehicle washing system as in claim 1, wherein each of the wands further comprises a rotating arm with a nozzle at or near each end of the arm.

3. A vehicle washing system as in claim 2, wherein each of the wands is half a foot long and wherein at least three wands are mounted on each tower.

4. A vehicle washing system as in claim 1, further comprising any combination of one or more fixed nozzles, oscillating nozzles, or both fixed and oscillating nozzles mounted on each tower.

5. A vehicle washing system as in claim 1, wherein the drive mechanism moves the towers about a vehicle by moving the carriage back and forth over the vehicle and by swinging the towers together behind and in front of the vehicle.

6. A vehicle washing system as in claim 5, further comprising rails made from four-inch by two-inch rectangular tubing that guide motion of the carriage.

7. A vehicle washing system as in claim 5, wherein the drive mechanism includes a first variable speed motor that moves the carriage back and forth and a second variable speed motor that swings the towers.

8. A vehicle washing system as in claim 1, further comprising any combination of one or more rotating wands with nozzles, fixed nozzles, oscillating nozzles, or fixed and oscillating nozzles mounted on the carriage so as to spray at least a top of the vehicle.

9. A vehicle washing system as in claim 8, further comprising a motor that drives any of the rotating wands mounted on the carriage.

10. A vehicle washing system as in claim 1, further comprising arms that connect the carriage to the towers.

11. A vehicle washing system as in claim 10, further comprising any combination of one or more rotating wands with nozzles, fixed nozzles, oscillating nozzles, or fixed and oscillating nozzles mounted on the arms so as to spray at least a top of the vehicle.

12. A method of washing a vehicle, comprising:
moving at least two towers attached to a carriage about a vehicle using a drive mechanism; and
spraying fluid under high pressure onto the vehicle though nozzles on a plurality of rotating wands recessed into each of the towers.

13. A method of washing a vehicle as in claim 12, wherein each of the wands further comprises a rotating arm with a nozzle at or near each end of the arm.

14. A method of washing a vehicle as in claim 13, wherein each of the wands is half a foot long and wherein at least three wands are mounted on each tower.

15. A method of washing a vehicle as in claim 12, further comprising the step of spraying fluid under high pressure onto the vehicle though any combination of one or more fixed nozzles, oscillating nozzles, or both fixed and oscillating nozzles mounted on each tower.

16. A method of washing a vehicle as in claim 12, wherein the drive mechanism moves the towers about a vehicle by moving the carriage back and forth over the vehicle and by swinging the towers together behind and in front of the vehicle.

17. A method of washing a vehicle as in claim 16, wherein motion of the carriage is guided by rails that are made from four-inch by two-inch rectangular tubing.

18. A method of washing a vehicle as in claim 16, wherein the drive mechanism includes a first variable speed motor that moves the carriage back and forth and a second variable speed motor that swings the towers.

19. A method of washing a vehicle as in claim 12, further comprising the step of spraying fluid under high pressure onto a top of the vehicle though any combination of one or more rotating wands with nozzles, fixed nozzles, oscillating nozzles, or fixed and oscillating nozzles mounted on the carriage.

20. A method of washing a vehicle as in claim 19, further comprising the step of driving any of the rotating wands mounted on the carriage with a motor.

21. A method of washing a vehicle as in claim 12, wherein arms connect the carriage to the towers.

22. A method of washing a vehicle as in claim 21, further comprising the step of spraying fluid under high pressure onto a top of the vehicle though any combination of one or more rotating wands with nozzles, fixed nozzles, oscillating nozzles, or fixed and oscillating nozzles mounted on the arms.
